(19) United States
(12) Patent Application Publication
(10) Pub. No.: US 2013/0054435 A1
(43) Pub. Date: Feb. 28, 2013

(54) System and Method for Dynamic Query Processing Based on Financial Information and Query Responses

(71) Applicants: Ye Zhang, Wilmington, DE (US); Vytas Kisielius, Wilton, CT (US); Garrett Baird, Philadelphia, PA (US)

(72) Inventors: Ye Zhang, Wilmington, DE (US); Vytas Kisielius, Wilton, CT (US); Garrett Baird, Philadelphia, PA (US)

(73) Assignee: Collections Marketing Center, Inc.

(21) Appl. No.: 13/217,832

(22) Filed: Aug. 25, 2011

(51) Int. Cl. G06Q 40/00

(52) U.S. Cl. 705/35

(57) ABSTRACT

Various systems, computer program products, and methods for resolving financial issues using dynamic query processing is described. For example, a method may include obtaining an attribute of a debtor having a financial issue. The attribute describes a prior history or action of the debtor. The method may include communicating a question to be posed to the debtor. The method may include receiving a response to the question such as via a web page. The method may include determining and communicating a follow-up question to be posed to the debtor based on the attribute of the debtor and the response to the question. The method may include receiving a follow-up response to the follow-up question. The method may include determining a proposal to resolve the financial issue based on the response and the follow-up response.

### FIELD OF THE INVENTION

The disclosure relates to query processing and in particular to query processing and execution using financial information, debtor behavior, and query responses.

### BACKGROUND OF THE INVENTION

Conventional query systems are typically designed for obtaining basic information for products or services. Even though some query systems may be dynamic in that a new question may depend upon an answer to a previous question, these systems fail to take into account a combination of the respondent's attributes such as history or behavior and prior answers.

In the context of debt collections, conventional systems typically use live telephone agents or simple online forms in order to obtain information from debtors regarding their debts. However, these systems fail to allow a creditor to configure what questions to ask, how to ask them, and which new questions should be asked based on various inputs such as a debtor's financial history, behavioral history, and previous responses to questions. As such, conventional systems fail to adequately capture sufficient information necessary to determine a comprehensive proposal set that is optimally likely to succeed in resolving a debt.

Thus, what is needed is a system and method for dynamic query processing that uses a debtor's financial history, behavioral history, and prior responses to questions in order to obtain the specific information that is most useful for maximizing the probability of successful debt resolution. These and other problems exist, which causes conventional systems and debt collection efforts based on those systems to be more expensive, less “customer-friendly”, and ultimately less effective for the users of those systems.

### SUMMARY OF THE INVENTION

Various systems, computer program products, and methods for resolving financial issues using dynamic query processing are described. For example, a method may include obtaining, by a computing device, an attribute of a debtor having a financial issue. The attribute describes a prior financial history or behavioral history of the debtor. In some implementations of the invention, the method may include communicating, by the computing device, a question to be posed to the debtor. In some implementations of the invention, the method may include receiving, by the computing device, a response to the question. The response is associated with the debtor. For example, the debtor may provide the response to the computing device via a web page. In some implementations of the invention, the method may include determining and communicating, by the computing device, a follow-up question to be posed to the debtor based on the attribute of the debtor and the response to the question. In some implementations of the invention, the method may include receiving, by the computing device, a follow-up response to the follow-up question. In some implementations of the invention, the method may include determining, by the computing device, a proposal to resolve the financial issue based on the response and the follow-up response.

### BRIEF DESCRIPTION OF THE DRAWINGS

The accompanying drawings, which are incorporated into and constitute a part of this specification, illustrate one or more examples of implementations of the invention and, together with the description, serve to explain various principles and aspects of the invention.

FIG. 1 is a block diagram illustrating a system for dynamic financial information query processing, according to various implementations of the invention.

FIG. 2 is a block diagram illustrating various channels used by a computing device for dynamic financial information query processing, according to various implementations of the invention.

FIG. 3 is a block diagram illustrating different follow-up questions based on attributes of debtors, according to various implementations of the invention.

FIG. 4 is a block diagram illustrating a rules-based engine for dynamically generating questions for debtors or proposals to resolve a financial issue, according to various implementations of the invention.

FIG. 5 is a block diagram illustrating an effectiveness engine for rating effectiveness of questions or communication channels, according to various implementations of the invention.

FIG. 6 is a flow diagram illustrating an example of a process for dynamic financial information query processing, according to various implementations of the invention.

### DETAILED DESCRIPTION OF THE INVENTION

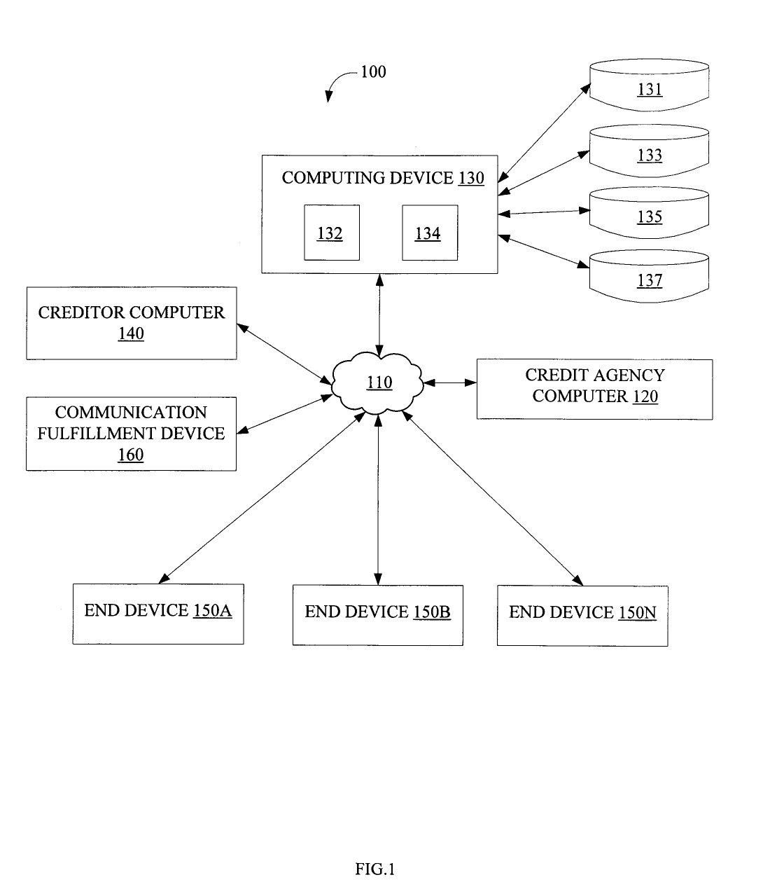

FIG. 1 is a block diagram illustrating a system 100 for dynamic financial information query processing, according to various implementations of the invention. According to various implementations of the invention, system 100 may generate data-driven debt resolution surveys that allow debtors and creditors to interact dynamically according to rules or configurations established by creditors. For example, a creditor may configure system 100 to utilize financial, behavioral, and/or customer-provided inputs to determine questions to ask each debtor. The questions may be selected so as to obtain from the debtor information for resolving a financial issue.

Accordingly, a question may be dynamically determined and tailored for each debtor based on not only debtor responses to prior questions but to one or more attributes (such as financial and/or behavioral history) of a debtor. In this manner, system 100 may communicate different questions to different debtors even though the different debtors provided the same response to a particular question. By determining which information to seek from a debtor based on an attribute of the debtor and a response by the debtor to a particular query, system 100 may be used to obtain relevant information for making decisions related to resolving a financial issue.

In some implementations of the invention, a financial issue may include delinquent credit accounts, hardship evaluations, bankruptcies, or other financial problems of debtors. In some implementations of the invention, system 100 may be used to perform hardship evaluations. For example, system 100 may generate a survey that includes questions requesting a debtor's income (e.g., wages, rental income, etc.) and expenses (e.g., housing, other creditor payments, food, utilities, etc.). In some implementations of the invention, system 100 may further evaluate financial attributes such as a balance, a number of days delinquent, a last payment amount, and behavioral attributes such as a latest web visit date, a HyperText Markup Language (“HTML”) link clicked in an email, a last email opened, a pending payment canceled, a payment program arrangement canceled, a chat invitation accepted, an Interactive Voice Response (“IVR”) authentication, a payment program view, a payment program presentment by live agent or an outcome of a recent discussion with a live agent. Any or all of the foregoing attributes may be included in a logical expression/rule to determine a next action. Accordingly, two debtors may answer the same question the same way and be presented different follow-up questions based on their individual attributes. In some implementations of the invention, the next action may include, without limitation, determining payment program eligibility, presenting a subsequent set of survey questions, presenting payment program offers, sending a communication to the debtor, and/or queuing the debtor for handling by a live agent. In some implementations of the invention, the debtor continues to interact with each subsequent action until reaching the creditor-prescribed completion of the process.

In some implementations of the invention, system 100 may generate a survey for bankruptcy processing by a creditor. In this example, system 100 may communicate questions to a creditor agent to efficiently gather only the data necessary to complete the process. In some implementations, bankruptcy processing questions may include, without limitation, whether the debtor has filed for bankruptcy, intends to file, has retained an attorney, has a bankruptcy case number, and/or other questions related to bankruptcy information. In some implementations of the invention, one or more of the predefined questions may be overridden when answers are already known based on the debtor's attributes.

The foregoing non-limiting examples of use and operation of system 100 are illustrative only. Further uses and implementations are described below with respect to various components and functions of system 100.

According to various implementations of the invention, system 100 may include, but is not limited to, a computing device 130, a credit agency computer 120, a creditor computer 140, an end device 150 (illustrated in FIG. 1 as end devices 150A, 150B, . . . , 150N), and communication fulfillment device 160. In some implementations of the invention, computing device 130 may include or otherwise be coupled to attribute database 131, query repository 133, rules database 135, and response repository 137. In some implementations of the invention, computing device 130, attribute database 131, query repository 133, rules database 135, response repository 137, credit agency computer 120, creditor computer 140, end device 150, and communication fulfillment device 160 may be communicably coupled to one another via a network 110. Network 110 may include a Local Area Network, a Wide Area Network, a cellular communications network, a Public Switched Telephone Network, and/or other network or combination of networks. In some implementations of the invention, end device 150 may include, without limitation, a telephone, a computer, a smartphone, a cellular phone, tablet computer, print shop and/or other device that can be used to contact debtors over network 110.

In some implementations of the invention, credit agency computer 120 provides provide credit scores, credit histories, and other information about debtors from a credit reporting agency or bureau. Credit agency computer 120 may include, for example, various devices and memories (not illustrated in FIG. 1) that store and make available such information to computing device 130.

In some implementations of the invention, creditor computer 140 provides payment histories, debts owed, credit limits, delinquency, and other information regarding debts owed by debtors to creditors. Creditor computer 140 may include, for example, various devices and memories (not illustrated in FIG. 1) that store and make available such information to computing device 130.

In some implementations of the invention, communication fulfillment device 160 provides indications of prior communication with the debtor. In some implementations, such prior communication may indicate prior behavior of the debtor. For example, communication fulfillment device 160 may provide data associated with a call using an IVR system with the debtor, an indication of the websites that were visited by the debtor, and/or other communications with the debtor.

In some implementations of the invention, computing device 130 may obtain an attribute of a debtor. In some implementations of the invention, the attribute describes a prior history or action/behavior of the debtor. For example, the attribute may include a financial attribute such as, without limitation, a credit score or history (such as a score or history from a credit reporting agency), a payment history, or a behavioral attribute that indicates a behavior or action by the debtor. The prior behavior may include, without limitation, contacting a creditor or debt collector regarding a debt owed, visiting a website of the creditor or debt collector, making a prior promise to pay, and/or other behavior by the debtor in relation to a debt owed.

In some implementations of the invention, the attribute is obtained dynamically from an attribute source such as credit agency computer 120, creditor computer 140, or communication fulfillment device 160. In some implementations of the invention, the attribute is obtained periodically and stored in attribute repository 131. In these implementations, attribute repository 131 may be updated periodically. In this manner, system 100 may dynamically obtain attributes of a debtor in real-time and/or may obtain attributes from storage (which can be updated periodically as updated information becomes available—such as when a change in credit score has occurred).

In some implementations of the invention, query repository 133 may include a plurality of questions that seek to obtain information related to resolving financial issues. Each of the plurality of questions may be either general questions to be asked of debtors or specific questions that are tailored by creditor 120 in order to obtain desired information. In some implementations of the invention, a creditor may add, update, or remove questions from query repository 133. In some implementations of the invention, added, updated, or removed questions may be used in or removed from the available pool of questions in real-time.

In some implementations of the invention, rules database 135 may include a plurality of rules that specify whether and how to ask questions, how to react to different responses to questions, and which proposals are appropriate to resolve a financial issue. In some implementations of the invention, a creditor may add, update, or remove rules from rules database 135. In some implementations of the invention, added, updated, or removed rules may immediately control outcomes, affecting surveys and proposals in real-time.

In some implementations of the invention, a rule includes one or a logical combination of variables that define further actions system 100 should take. For example, a rule may specify that if attributes of a debtor include a balance that is greater than 1000, a risk score is greater than 600, a number of days delinquent is greater than 30 days, and a response to a question is “Temporary Hardship,” then a particular question or series of questions should be asked. In some implementations of the invention, the rules may be associated with a survey such that the survey includes rules and questions to be asked. In these implementations, the creditor may publish the survey and its accompanying logic/rules using one of a plurality of communication channels. In some implementations of the invention, new or updated surveys/questions are available substantially immediately after creation.

In some implementations of the invention, response repository 137 may include prior responses to questions. Response repository 137 may be used to view historical responses by various debtors to various questions. In some implementations of the invention, whether a question is effective at obtaining information may be determined based on the historical responses.

In some implementations of the invention, computing device 130 may communicate a question to be posed to the debtor. In some implementations of the invention, computing device 130 may determine the question to be posed based on the attribute. For example, based on a debtor's credit score, payment history, prior behavior, and/or other attribute, computing device 130 may select the question from among a plurality of questions in question repository 133. In some implementations of the invention, computing device 130 may use rules from rules database 135 in order to determine the question, other questions, and/or follow-up questions. In some implementations of the invention, the rules may be specific for a particular creditor or may be generally used by all creditors. The custom and general rules are not necessarily mutually exclusive, as they may overlap.

In some implementations, for example, a particular creditor may wish to obtain certain information when a debtor has fallen behind on their payments. The rules may be tailored such that the particular creditor may ascertain information from the debtor in order to define how computing device 130 and/or collection efforts should proceed. In these implementations, computing device 130 may expose an interface (not illustrated in FIG. 1) such that creditors may customize rules for individual or all debtors.

In some implementations of the invention, the question may be posed via an IVR system, an online survey, a call center handled by an agent, a Short Message Service (“SMS”) or other text messaging service, email, courier mail, or other method by which questions may be communicated.

In some implementations of the invention, computing device 130 may receive a response to the question, where the response is associated with the debtor. For example, computing device 130 may receive a response to the question from the debtor via the IVR system, a web page, a call with a call center agent, a text message, an email, or mail.

In some implementations of the invention, computing device 130 may determine a follow-up question to be posed to the debtor based on the attribute of the debtor and the response to the question. For example, based on information already known about the debtor (such as from credit agency computer 120, creditor computer 140, or other information known by computing device 130 about the debtor) and the response from the debtor, computing device 130 may determine a follow-up question for the debtor. In this manner, computing device 130 leverages both responses from the debtor and contextual attribute information (different than responses to prior questions) already known by computing device 130 in order to determine further questions for obtaining relevant information from the debtor.

In some implementations of the invention, computing device 130 may determine a proposal to resolve the financial issue based on the response and the follow-up response. In some implementations, the proposal is based on information already known about the debtor from prior responses and/or attribute information.

In some implementations of the invention, the proposal may include a payment plan or whether to grant a forbearance associated with repayment of a debt. For example, based on responses and/or debtor attributes, computing device 130 may propose a particular payment term to be accepted by the debtor in order to resolve the financial issue.

In some implementations of the invention, a strategy for dealing with the debtor is used prior to receiving the response and the follow-up response. For example, the strategy may include a communication channel that should be used (i.e., whether to email, text message, call, mail written notices, etc.), whether to offer methods of repayment, which debt collection agents are used, and/or other known strategies associated with dealing with debtors. In these implementations, the proposal may include a different strategy for dealing with the debtor based on the response, follow-up response, and/or debtor attribute. In other words, computing device 130 may propose to change the strategy for dealing with the debtor based on responses to questions, follow-up questions, and/or information known about the debtor.

In some implementations of the invention, a particular amount of information is needed to propose the resolution. In other words, different financial issues may require different amounts (i.e., types and/or level of detail) of information about the debtor in order to propose a resolution to the financial issue. For example, different or less detailed information about a debtor having late payments on a credit card may be desired than that for a debtor who is at risk for declaring bankruptcy. In these implementations, computing device 130 accounts for the different amounts of information required to propose a resolution.

In some implementations of the invention, computing device 130 may filter a question to be posed from a plurality of predefined questions in query repository 133 based on information sought by the plurality of questions, the amount of information needed to propose a resolution, and information already known about the debtor. For example, if an answer to a question in query repository 133 is already known based on the attributes, prior responses to questions or other information known about the debtor, computing device 130 may ignore, skip, or otherwise not communicate the question, thereby reducing redundancy and streamlining information collection.

In some implementations of the invention, computing device 130 may iteratively propose new follow-up questions to be posed and receive responses to the new follow-up questions until the particular amount of information is obtained. In some implementations of the invention, this iterative process may continue until relevant questions in query repository 133 are exhausted (in which case computing device 130 may alert an administrator or debt collector), until a predefined number of questions have already been asked/attempted, the debtor discontinues communication, and/or other suitable end point.

In some implementations of the invention, computing device 130 may determine which ones of a plurality of predefined questions are effective at obtaining at least a portion of the particular amount of information. For example, each question may be ranked for their effectiveness. In some implementations of the invention, the ranking may be based on all or a portion of prior responses in response repository 137 (whether for one or many debtors) to each question. In some implementations of the invention, the ranking may be based on successful resolution of financial issues for which the question was asked (such as whether or how much a debt was repaid using a payment plan that was determined based on a response to the question).

In some implementations of the invention, computing device 130 may determine which ones of a plurality of communication channels are effective at obtaining at least a portion of the particular amount of information. In some implementations of the invention, the effectiveness of communication channels may be determined in a manner similar to determining effectiveness of questions (i.e., ranking/scoring, etc.). In some implementations of the invention, computing device 130 may determine the effectiveness of different combinations of questions and communication channels in a manner similar to determining effectiveness of questions.

In some implementations of the invention, computing device 130 may obtain a second attribute of a second debtor different than the debtor. For example, computing device 130 may repeat the same process for a second debtor different from the debtor described above. In some implementations, computing device 130 may communicate the question to be posed to the second debtor. In other words, the same question may be posed to both the debtor and the second debtor.

In some implementations of the invention, computing device 130 may receive a second response to the question, the second response being the same as the response. For example, the second debtor may have provided the same answer to the question as the debtor described above.

In some implementations of the invention, computing device 130 may determine a second follow-up question to be posed to the second debtor based on the second attribute of the second debtor and the second response to the question, where the first follow-up question is different from the second follow-up question based on differences between the attribute and the second attribute. In other words, even though the debtor and the second debtor provided the same response to the same question, computing device 130 determines different follow-up questions for the different debtors based on their respective attribute information. In this example, the response is used by computing device 130 to determine a follow-up question, but the follow-up questions are different because of differences between attribute information of each debtor.

Although the above example illustrates different follow-up questions for different debtors even though the same response to a question was given by both debtors, in some implementations different debtors may receive different follow-up questions based on differences in their respective responses to the same question. Furthermore, in some implementations, different debtors may receive the same follow-up question based on their responses and attribute information.

In some implementations of the invention, computing device 130 may communicate the question via a web page presented by computing device 130, a telephonic interview with a live agent, an interview via IVR, a text message, an email, or mail.

In some implementations of the invention, computing device 130 may determine a financial status of the debtor based on the response to a question associated with (e.g., provided by) the debtor. For example, based on the debtor's responses to questions, computing device 130 may ascertain that a debtor is contemplating or has filed for bankruptcy. In some implementations of the invention, computing device 130 may determine a financial status of the debtor based on the response to a question and attribute information associated with the debtor. For example, based on both an attribute (such as prior history of credit defaults) of the debtor and the debtor's response to a question (such as indicating a willingness to declare bankruptcy), computing device 130 may determine that the debtor will likely file for bankruptcy. In this manner, computing device 130 may make decisions and/or recommendations regarding one or more accounts of the debtor depending on the determined financial status.

In some implementations of the invention, computing device 130 may determine a payment plan or whether to grant a forbearance associated with repayment of a debt based on a response to a question. For example, based on a response to a question regarding an ability to pay each month, computing device 130 may determine a payment plan. In some implementations of the invention, computing device 130 may determine a payment plan associated with repayment of a debt based on a response to a question (such as the debtor's ability or willingness to pay) and attribute information associated with the debtor (such as whether the debtor has a poor payment or credit history). In some implementations, computing device 130 may determine that the debtor will be unable to pay based on one or more responses or follow-up responses to questions. In these implementations, computing device 130 may propose to grant a forbearance.

According to various implementations of the invention, computing device 130 may include a processor 132, a memory 134, and/or other components that facilitate the functions of computing device 130 described herein. In some implementations of the invention, processor 132 includes one or more processors configured to perform various functions of computing device 130. In some implementations of the invention, memory 134 includes one or more tangible (i.e., non-transitory) computer readable media. Memory 134 may include one or more instructions that, when executed by processor 132, configure processor 132 to perform the functions of computing device 130.

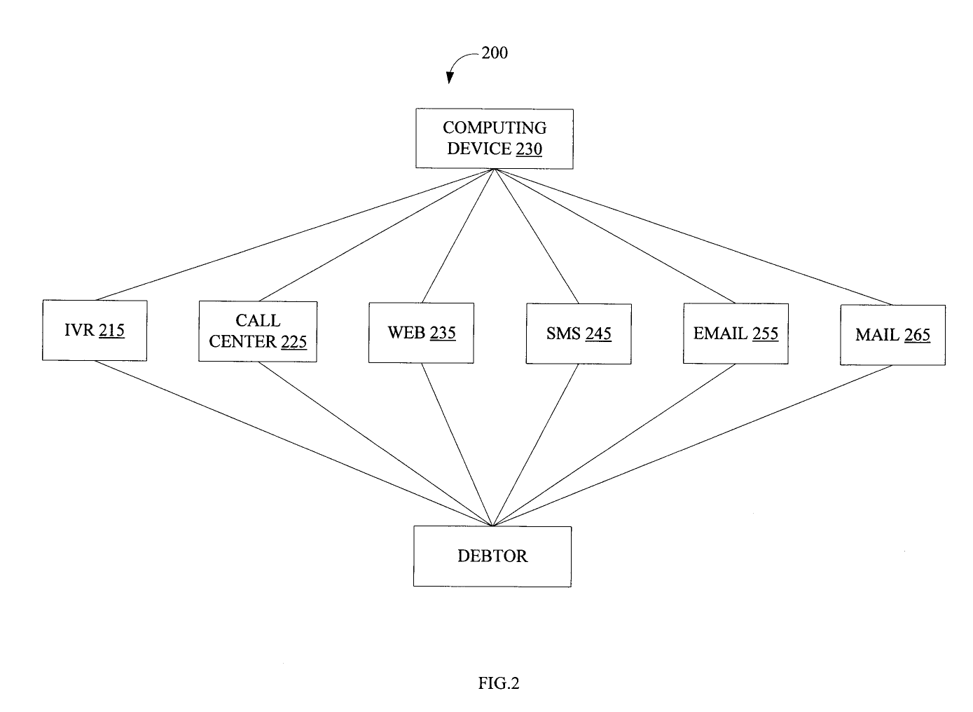

FIG. 2 is a block diagram illustrating various channels used by computing device 230 for dynamic financial information query processing, according to various implementations of the invention. In some implementations of the invention, computing device 230 may use an IVR channel 215, a call center channel 225, a web channel 235, an SMS channel 245, an email channel 255, and a mail channel 265. Whichever channel is used, computing device 230 may determine questions and follow-up questions to be posed to a debtor in order to gather information that may be relevant to collect a debt from the debtor. In some implementations of the invention, computing device 230 may receive responses to questions in multiple choice or open text format based on the type of channel being used (such as reading a web form when using web channel 235 or bubbled responses when using mail channel 265).

In some implementations of the invention, computing device 230 uses an IVR channel 215. In these implementations, computing device 230 includes or otherwise uses an IVR system to communicate with a debtor. Via IVR channel 215, computing device 230 may pose one or more questions and one or more follow-up questions to the debtor. For example, the questions or follow-up questions may be posed using a multiple-choice format, a response to which may be entered by the debtor using a touch-tone phone. In other examples, the IVR system may record open-ended responses to questions or follow-up questions for speech-to-text or live analysis and data entry. In either case, computing device 230 may receive responses from the debtor to the posed questions or follow-up questions via IVR channel 215.

In some implementations of the invention, computing device 230 uses a call center channel 225. In these implementations, computing device 230 may expose a call center interface that a call center agent (i.e., a human operator) uses to receive questions and follow-up questions. The call center agent may contact the debtor, read out questions and input responses from the debtor. In some implementations of the invention, the call center interface includes multiple choice format and/or open text format so that the call center agent may input appropriate responses from the debtor. In this manner, computing device 230 may receive responses and follow-up responses from the debtor via the call center agent.

In some implementations of the invention, computing device 230 uses a web page communication channel 235. In these implementations, computing device 230 may expose a web page that communicates the questions and follow-up questions and receives responses from the debtor via multiple choice selections and/or open text input. In some implementations of the invention, the web page is secured and requires login credentials. For example, the debtor may be invited via various communication channels to visit the web page, login, and provide answers to questions as described herein.

In some implementations of the invention, computing device 230 uses a text message channel 245. In these implementations, computing device 230 may include or otherwise use a text messaging service that communicates questions to debtors via text message to a debtor's device. Responses to the questions may be input by the debtor via reply text message(s). In some implementations, the response format may be multiple choice (such as a reply message that includes a letter or number corresponding to a preset answer) or open text.

In some implementations of the invention, computing device 230 uses an email channel 255. In these implementations, computing device 230 may include or otherwise use an email service that communicates questions to debtors via email to a debtor's email address. Responses to the questions may be input by the debtor via reply email. In some implementations, the response format may be multiple choice (such as a reply email that includes a letter or number corresponding to a preset answer) or open text.

In some implementations of the invention, computing device 230 uses a mail channel 265. In these implementations, computing device 230 may cause questions to be mailed to debtors in hard copy to the debtor's mailing address. The questions may be pre-selected for the debtor. Responses to the questions may be input by the debtor via circling or bubbling multiple choice formats or writing (typing, handwriting, etc.) responses into open text areas. In some implementations, computing device 230 may automatically read the responses (such as bubbled responses) and/or the responses may be input to computing device 230 by a human operator or optical recognition device.

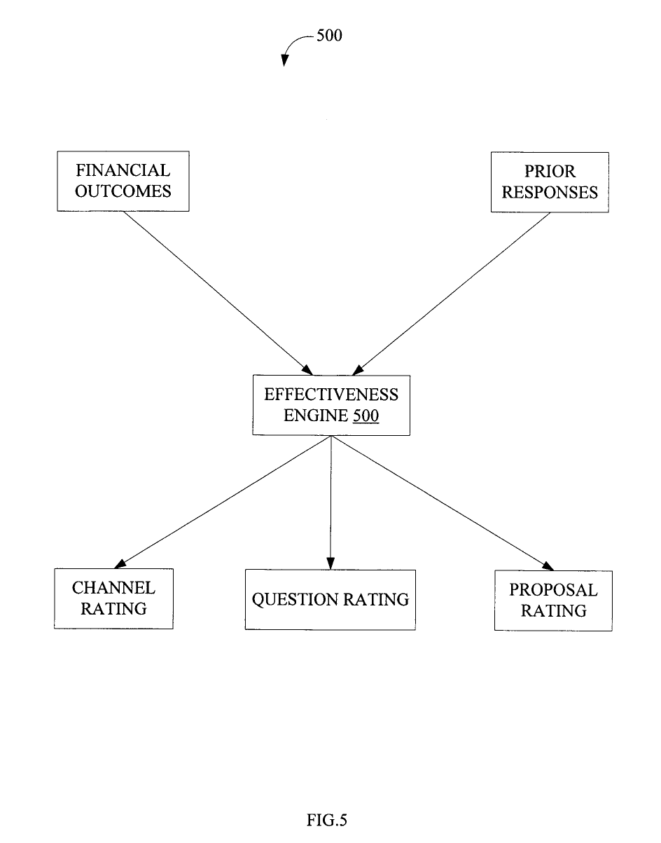

In some implementations of the invention, computing device 230 may use a particular communication channel predicted to be most effective at obtaining responses, as discussed with respect to FIG. 5 below. In some implementations of the invention, computing device 230 may use a combination of two or more channels to obtain responses. In these implementations, certain types of questions may be more effectively communicated in one communication channel than another.

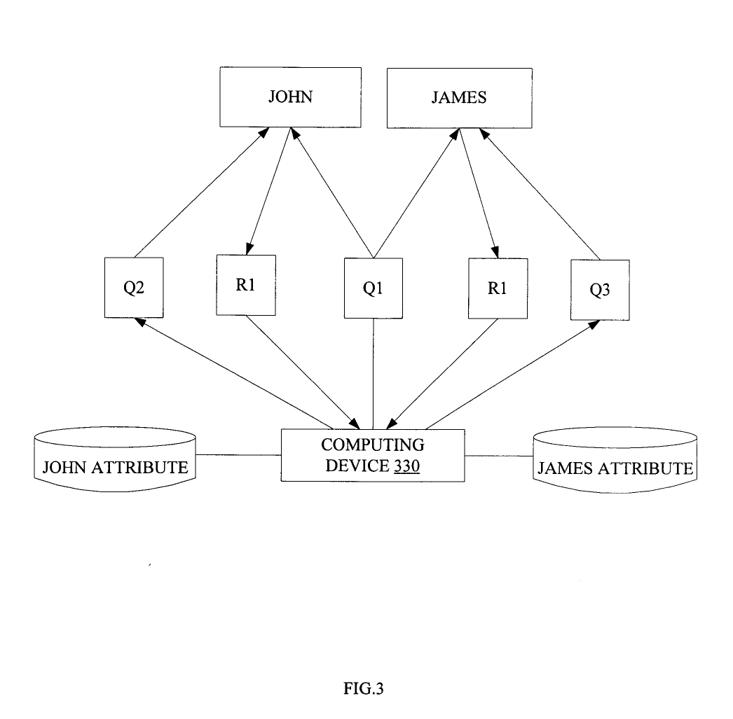

FIG. 3 is a block diagram illustrating different follow-up questions based on attributes of debtors, according to various implementations of the invention. As illustrated in FIG. 3, different debtors (illustrated as “John” and “James”) have different attributes associated with them (illustrated as “John attributes” and “James attributes”). In some implementations of the invention, computing device 330 may communicate the same question (illustrated as “Q1”) to both John and James, who both reply to Q1 with the same response (illustrated as “R1”). Thus, as illustrated, both John and James were posed with the same question and provided the same response (such as the same multiple choice answer or similar open text/speech).

In some implementations of the invention, computing device 330 may determine a plurality of potential follow-up questions based on different responses. In other words, response R1 may be associated with different potential follow-up questions than a different response. In some implementations, the potential follow-up questions may be based on rules described above with respect to FIG. 1.

In some implementations of the invention and as illustrated, computing device 330 may determine follow up questions (“Q2” and “Q3”) to be posed to John and James based on R1 and respective attributes for John and James. Even though John and James provided the same response R1 to Q1, they each receive different follow-up questions Q2 and Q3 because their attributes are different. In some implementations, computing device 330 selects Q2 and Q3 from among the range of potential follow-up questions associated with R1. In this manner, computing device 330 filters questions based on R1 and further filters questions based on debtor attributes.

The questions determined may include, for example, asking a debtor the reason for his delinquency (lost job, unforeseen medical expenses, unexpected other expenses, death in family, divorce, other hardship) from a set of answers put forth by the creditor that then drives follow up questions specific to that situation. Relevant financial attributes can then be examined and follow up questions as to the length and severity of the given reason for delinquency may be pursued. Once the severity of the situation is recorded or otherwise determined by the system, the ability to pay can be ascertained by asking additional follow-up questions related to the exact income and expenses profile of the debtor to determine a suitable offer based on response and attribute-driven questions.

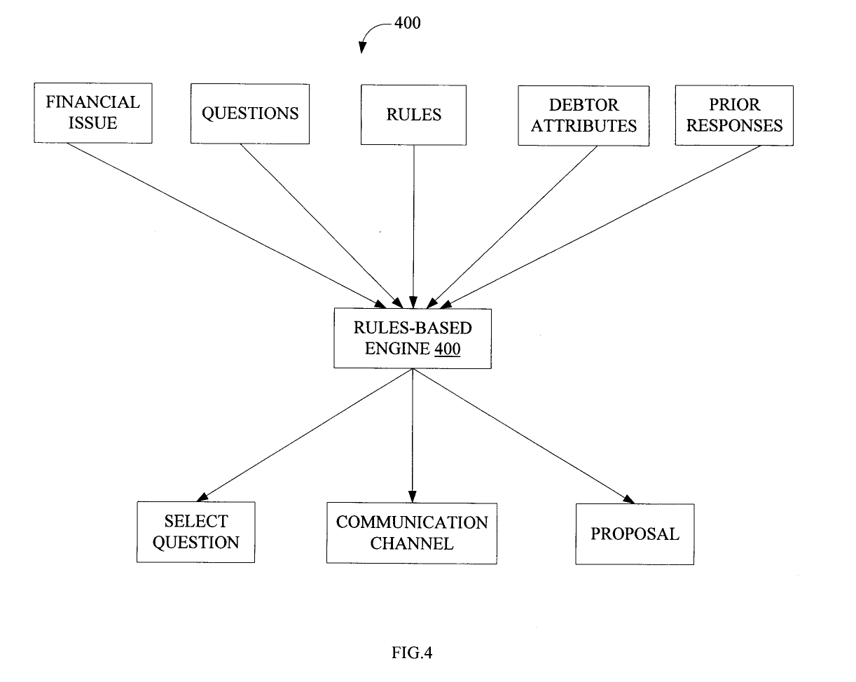

FIG. 4 is a block diagram illustrating a rules-based engine 400 for dynamically generating questions for debtors or proposals to resolve a financial issue, according to various implementations of the invention. In some implementations of the invention, rules-based engine 400 may be implemented by a computing device such as computing devices 130, 230, 330 illustrated in FIGS. 1, 2, and 3.

In some implementations of the invention, rules-based engine 400 may obtain an indication of a type of financial issue, a plurality of questions, a plurality of rules, attributes of debtors, and/or prior responses from debtors. In some implementations of the invention, the plurality of questions or the plurality of rules may be customized by a creditor to which a debt is owed by a debtor. In some implementations of the invention, each of the rules may include logic (such as software or other instructions) that rules-based engine 400 uses in order to make decisions about which questions to ask, how to ask them, and which proposals should be made to address financial issues.

In some implementations of the invention, each of the questions may be associated with a rule that determines when the question should be asked. For example, a rule may specify that a question should be considered a potential question or follow-up question for debtors having particular attributes and/or giving particular responses to a prior question.

In some implementations of the invention, a rule may specify that a question should be communicated over a particular communication channel. For example, a rule may specify that a question should be communicated via a web page.

In some implementations of the invention, a rule may specify information required to resolve a particular type of financial issue. For example, a rule may indicate that a debtor's credit score, payment history, and current income may be necessary to determine a payment plan for a delinquent credit card account. In some implementations of the invention, a rule may specify which questions to ask in order to obtain the required information (if such information is unknown or outdated).

In some implementations of the invention, a rule may specify which actions to take based on a particular response to a question, attribute, or other information about the debtor. For example, a rule may specify a proposal such as a particular payment plan based on a response to question, an attribute of a debtor, and/or a type of financial issue to be resolved.

In another non-limiting example, a rule may specify a next question or set of questions based on a response in combination with a debtor's attribute such as when evaluating an income and expense form (series of questions). When evaluating the information provided by the customer, a rule may set certain tolerance levels using debtor attributes in the system to assess the validity of answers provided by the debtor, and then driving a resulting follow up question. For example, an income that is +/−50% of the income reported at the time of account establishment would generate a different follow up question than an income within that range.

In another non-limiting example, a rule that may specify a next question or set of questions based on a response to a prior question in combination with a financial issue to be resolved such as when presenting a payment program offer to a debtor. When a series of questions leads to a decision to present a particular payment program to that debtor, his acceptance or rejection of that proposed resolution in combination with previous questions answered can drive the next question asked of the debtor.

In this manner, using the plurality of rules, rules-based decision engine 400 may determine which questions to ask, how to ask them, and/or proposals to resolve financial issues by debtors. In some implementations of the invention, rules are not mutually exclusive. In other words, one rule may be used in combination with another rule.

FIG. 5 is a block diagram illustrating an effectiveness engine 500 for rating effectiveness of questions or communication channels, according to various implementations of the invention. In some implementations of the invention, effectiveness engine 500 may be used by rules-based engine 400 illustrated in FIG. 4 in order to determine which questions to ask or how to ask them. For example, effectiveness engine 500 may be used to further filter which questions to ask in order to obtain information needed to resolve a financial issue. As such, effectiveness engine 500 may be implemented by a computing device such as computing devices 130, 230, and 330 illustrated in FIGS. 1, 2, and 3.

In some implementations of the invention, effectiveness engine 500 may determine a score or ranking (hereinafter “rating”) for a question and/or communication channel. The rating may be determined based on various assessments for effectiveness described below.

In some implementations of the invention, effectiveness engine 500 may assess a question for its effectiveness in obtaining responses. For example, effectiveness engine 500 may rate a question based on whether the question receives a response from the debtor. In this example, effectiveness engine 500 may analyze all or a portion of prior responses to the question and may determine whether a response was obtained. Similarly, effectiveness engine 500 may assess a communication channel based on its effectiveness in obtaining a response (i.e., a web page channel for a particular question is more effective at obtaining a response than a telephone call).

In some implementations of the invention, effectiveness engine 500 may rate a question based on a final disposition or outcome of the financial issue associated with the question. In other words, a question's rating may be based on whether the financial issue for which the question is asked was resolved. For example, a question associated with unresolved financial issues may be rated lower than a question that tends to be associated with resolved financial issues. Similarly, effectiveness engine 500 may assess a communication channel based on whether financial issues were unresolved or resolved.

In some implementations of the invention, effectiveness engine 500 may rate a proposal to resolve different financial issues. For example, based on prior proposals and their ultimate outcomes, effectiveness engine 500 may determine effectiveness of different proposals.

In some implementations of the invention, effectiveness engine 500 may generate reports that illustrate effectiveness of questions and proposals. Such reports may be accessed by creditors and others in order to determine strategies for dealing with debtors. For example, creditors may use the reports to generate updated rules based on which questions are more effective in different situations/financial issues.

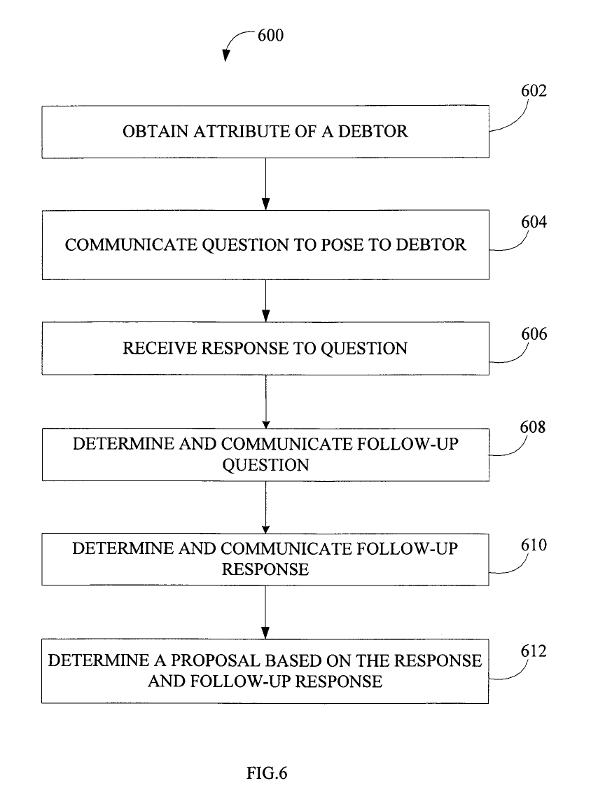

FIG. 6 is a flow diagram illustrating an example of a process for dynamic financial information query processing, according to various implementations of the invention. The various processing operations and/or data flows depicted in FIG. 6 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations of the invention, in an operation 602, process 600 may include obtaining an attribute of a debtor having a financial issue, the attribute describing a prior history or action of the debtor.

In some implementations of the invention, in an operation 604, process 600 may include communicating a question to be posed to the debtor.

In some implementations of the invention, in an operation 606, process 600 may include receiving a response to the question, wherein the response is associated with the debtor.

In some implementations of the invention, in an operation 608, process 600 may include determining and communicating a follow-up question to be posed to the debtor based on the attribute of the debtor and the response to the question.

In some implementations of the invention, in an operation 610, process 600 may include receiving a follow-up response to the follow-up question.

In some implementations of the invention, in an operation 612, process 600 may include determining a proposal to resolve the financial issue based on the response and the follow-up response.

Implementations of the invention may be made in hardware, firmware, software, or any suitable combination thereof. Implementations of the invention may also comprise instructions stored on a machine readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A computer-implemented method for resolving financial issues using dynamic query processing, comprising:
obtaining, by a computing device, an attribute of a debtor having a financial issue, the attribute describing a financial or behavioral history of the debtor;
communicating, by the computing device, a question to be posed to the debtor;
receiving, by the computing device, a response to the question, wherein the response is associated with the debtor;
determining and communicating, by the computing device, a follow-up question to be posed to the debtor based on the attribute of the debtor and the response to the question;
receiving, by the computing device, a follow-up response to the follow-up question; and
determining, by the computing device, a proposal to resolve the financial issue based on the response and the follow-up response.

2. The computer-implemented method of claim 1, wherein the financial history comprises a credit history, a credit score, or a payment history, and wherein a behavioral history comprises a web site visit, a telephone call, an authentication to an automated telephone call, an email view, an HTML link clicked in email, a web page view, an offer presented to a debtor, a pending payment canceled, a program enrollment canceled, or an attempt to contact a creditor or debt collector.

3. The computer-implemented method of claim 1, further comprising:
obtaining, by the computing device, a second attribute of a second debtor different than the debtor;
communicating, by the computing device, the question to be posed to the second debtor;
receiving, by the computing device, a second response to the question, the second response being the same as the response; and
determining, by the computing device, a second follow-up question to be posed to the second debtor based on the second attribute of the second debtor and the second response to the question,
wherein the first follow-up question is different from the second follow-up question based on differences between the attribute and the second attribute.

4. The computer-implemented method of claim 1, further comprising:
obtaining, by the computing device, a second attribute of a second debtor different than the debtor;
communicating, by the computing device, the question to be posed to the second debtor;
receiving, by the computing device, a second response to the question, the second response being different from the response; and
determining, by the computing device, a second follow-up question to be posed to the second debtor based on the second attribute of the second debtor and the second response to the question,
wherein the first follow-up question is different from the second follow-up question based on differences between the response and the second response.

5. The method of claim 1, wherein communicating a question comprises communicating a question via a communication channel, the communication channel comprising: a web page, a telephonic interview, an interactive voice response call, a text message, an email, or mail.

6. The method of claim 1, wherein determining a proposal further comprises:
determining a financial status of the debtor based on the response.

7. The method of claim 1, wherein determining a proposal further comprises:
determining a payment plan or whether to grant a forbearance associated with repayment of a debt based on the response.

8. The method of claim 1, wherein a strategy for dealing with the debtor is used prior to receiving the response and the follow-up response, and wherein determining a proposal further comprises:
determining a different strategy for dealing with the debtor based on the response and the follow-up response.

9. The method of claim 1, wherein a particular amount of information is needed to propose the resolution.

10. The method of claim 9, further comprising:
filtering the question from a plurality of predefined questions based on information sought by the plurality of questions and information already known about the debtor.

11. The method of claim 9, further comprising:
iteratively proposing new follow-up questions to be posed and receiving responses to the new follow-up questions until the particular amount of information is obtained.

12. The method of claim 9, further comprising:
determining which ones of a plurality of predefined questions are effective at obtaining at least a portion of the particular amount of information.

13. The method of claim 9, further comprising:
determining which ones of a plurality of communication channels are effective at obtaining at least a portion of the particular amount of information.

14. A system for resolving financial issues using dynamic query processing, comprising:
a computing device comprising a processor configured to:
obtain an attribute of a debtor having a financial issue, the attribute describing a financial or behavioral history of the debtor;
communicate a question to be posed to the debtor;
receive a response to the question, wherein the response is associated with the debtor;
determine and communicate a follow-up question to be posed to the debtor based on the attribute of the debtor and the response to the question;
receive a follow-up response to the follow-up question; and
determine a proposal to resolve the financial issue based on the response and the follow-up response.

15. The system of claim 14, wherein the financial history comprises a credit history, a credit score, or a payment history, and wherein a behavioral history comprises a web site visit, a telephone call, authentication to an automated telephone call, an email view, an HTML link clicked in email, a web page view, an offer presented to a debtor, a pending payment canceled, a program enrollment canceled, or an attempt to contact a creditor or debt collector.

16. The system of claim 14, the computing device further configured to:
obtain a second attribute of a second debtor different than the debtor;
communicate the question to be posed to the second debtor;
receive a second response to the question, the second response being the same as the response; and
determine a second follow-up question to be posed to the second debtor based on the second attribute of the second debtor and the second response to the question,
wherein the first follow-up question is different from the second follow-up question based on differences between the attribute and the second attribute.

17. The system of claim 14, the computing device further configured to:
obtain a second attribute of a second debtor different than the debtor;
communicate the question to be posed to the second debtor;
receive a second response to the question, the second response being different from the response; and
determine a second follow-up question to be posed to the second debtor based on the second attribute of the second debtor and the second response to the question,
wherein the first follow-up question is different from the second follow-up question based on differences between the response and the second response.

18. The system of claim 14, wherein the question is communication via a communication channel, the communication channel comprising: a web page, a telephonic interview, an interactive voice response call, a text message, an email, or mail.

19. The system of claim 14, the computing device further configured to:
determine a financial status of the debtor based on the response.

20. The system of claim 14, the computing device further configured to:
determine a payment plan or whether to grant a forbearance associated with repayment of a debt based on the response.

21. The system of claim 14, wherein a strategy for dealing with the debtor is used prior to receiving the response and the follow-up response, the computing device further configured to:
determine a different strategy for dealing with the debtor based on the response and the follow-up response.

22. The system of claim 14, wherein a particular amount of information is needed to propose the resolution.

23. The system of claim 22, the computing device further configured to:
filter the question from a plurality of predefined questions based on information sought by the plurality of questions and information already known about the debtor.

24. The system of claim 22, the computing device further configured to:
iteratively propose new follow-up questions to be posed and receive responses to the new follow-up questions until the particular amount of information is obtained.

25. The system of claim 22, the computing device further configured to:
determine which ones of a plurality of predefined questions are effective at obtaining at least a portion of the particular amount of information.

26. The system of claim 22, the computing device further configured to:
determine which ones of a plurality of communication channels are effective at obtaining at least a portion of the particular amount of information.
